(19) United States
(12) Patent Application Publication
(10) Pub. No.: US 2017/0161814 A1
(43) Pub. Date: Jun. 8, 2017

(54) DISCOVERING PRODUCTS IN ITEM INVENTORY

(71) Applicant: eBay Inc., San Jose, CA (US)

(72) Inventors: Atiq Islam, San Jose, CA (US); Ravindra Sharma, San Jose, CA (US); Saratchandra Indrakanti, Sunnyvale, CA (US)

(21) Appl. No.: 14/961,212

(22) Filed: Dec. 7, 2015

(51) Int. Cl. G06Q 30/06

(52) U.S. Cl. CPC G06Q 30/0625

(57) ABSTRACT

In various example embodiments, a system and method for discovering products in an item inventory are presented. The system receives a corpus of item information listings respectively describing items that are categorized in the same category and including titles but no product identifiers. The system generates a plurality of candidate phrases based on the plurality of titles. The system prunes insignificant phrases from the plurality of candidate phrases to identify a plurality of pruned candidate phrases. The system matches each of the titles to a pruned candidate phrase based on the significance information to identify matched pruned candidate phrases. The matching includes identifying a longest pruned candidate phrase that matches each of the titles. The system stores matched pruned candidate phrases as qualified product titles in the listings to generate a productized corpus of item information and communicates the productized corpus of item information to the sender.

### TECHNICAL FIELD

Embodiments of the present disclosure relate generally to data processing and, more particularly, but not by way of limitation, to discovering products in item inventory.

### BACKGROUND

Listings may be used to describe items or services that are being offered for sale in a network-based marketplace. Some listings may include product identifiers that enable identifying an immediate and full description of the item or service. Other listings do not include product identifiers.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a system to discover products in an inventory, according to an example embodiment;

FIG. 2 is a block diagram illustrating product discovery applications, according to an example embodiment;

FIG. 3A is a block diagram illustrating item information, according to an example embodiment;

FIG. 3B is a block diagram illustrating a listing, according to an example embodiment;

FIG. 3C is a block diagram illustrating a category query information, according to an example embodiment;

FIG. 3D is a block diagram illustrating a corpus of item information, according to an example embodiment;

FIG. 4 is a block diagram illustrating a sequence of steps to generate candidate phrases, according to an example embodiment;

FIG. 5 is a block diagram illustrating a sequence of steps to identify pruned candidate phrases, according to an example embodiment;

FIG. 6A is a block diagram illustrating a candidate phrases by title matrix, according to an example embodiment;

FIG. 6B is a block diagram illustrating title phrases, according to an example embodiment;

FIG. 7A is a block diagram illustrating an S-matrix, according to an example embodiment;

FIG. 7B is a block diagram illustrating the U-matrix, according to an example embodiment;

FIG. 7C is a block diagram illustrating a U-matrix, according to an example embodiment, that is pruned;

FIG. 8 is a block diagram illustrating a sequence of steps to identify a matched pruned candidate phrase, according to an example embodiment.

FIG. 9A is a block diagram illustrating a method to discover products 508, according to an example embodiment;

FIG. 9B is a block diagram illustrating a method to prune insignificant phrases, according to an example embodiment;

FIG. 10 is a block diagram illustrating a system to discover products in an inventory, according to an example embodiment;

FIG. 11 is a block diagram illustrating a representative software architecture, which may be used in conjunction with various hardware architectures herein described;

FIG. 12 is a block diagram illustrating a machine, according to some example embodiments;

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative example embodiments of the disclosure. In the following description, for the purposes of explanation, numerous specific details are set forth in order to provide an understanding of various example embodiments. It will be evident, however, to those skilled in the art, that example embodiments of the subject matter herein may be practiced without these specific details. In general, well-known instruction instances, protocols, structures, and techniques are not necessarily shown in detail.

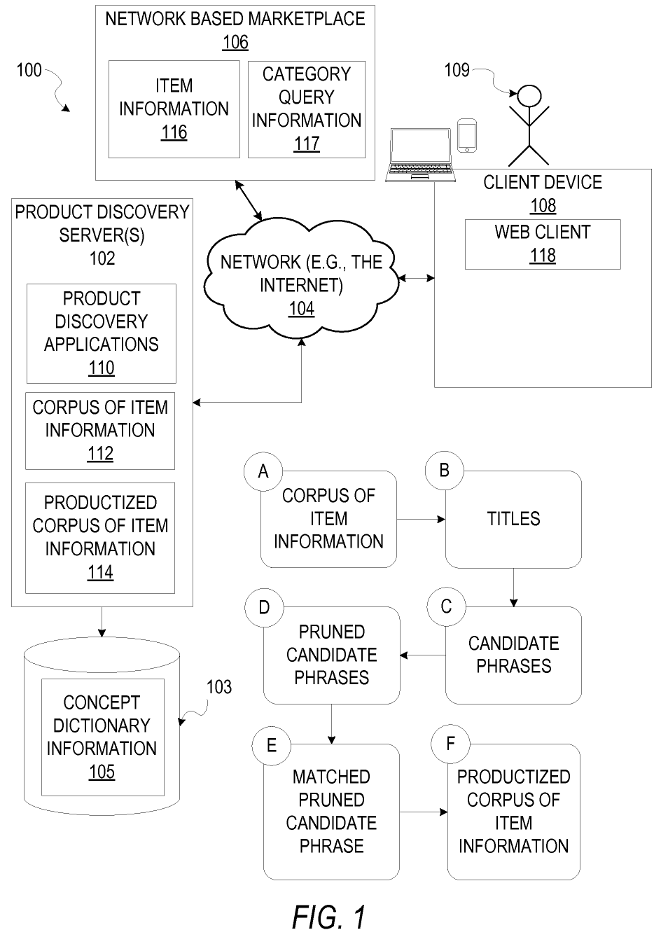

FIG. 1 is a block diagram illustrating a system 100 to discover products in an item inventory, according to an example embodiment. The system 100 may include product discovery servers 102 communicating over a network 104 (e.g., the Internet) with a network-based marketplace 106 and a client device 108. The product discovery servers 102 may include product discovery applications 110 to receive and process a corpus of item information 112 from the network-based marketplace 106. To this end, the product discovery applications 110 are communicatively coupled to a database 103 that stores concept dictionary information 105. Further, the product discovery applications 110 may generate and send a productized corpus of item information 114 including product identifiers and communicate productized corpus of item information 114 back to the network-based marketplace 106. Specifically, the product discovery servers 102 process listings in the item information 116 to generate qualified product titles, store the qualified product titles as product identifiers in the listings and communicate the listings as productized corpus of item information 114 back to the network-based marketplace 106. The listings describe items or services that are for sale on the network-based marketplace 106. The product discovery servers 102 process the listings to generate product identifiers in the form of quality product titles for listings that are identified as not having a product identifier and further identified as being registered in a specified category.

The product discovery servers 102 discover latent products in the corpus of item information 112 and assign qualified product titles by utilizing, among other things, a singular value decomposition (SVD) algorithm, as described further below. Describing an item or a service with a qualified product title normalizes an inventory in the same way as other product identifiers. Consider an inventory including a listing that describes a book that is being offered for sale on the network-based marketplace 106 but without a product identifier (e.g., International Standard Book Number (ISBN)). The book may be sold but additional effort may be required by an administrator for the marketplace, buyer, seller, and the like, to determine the salient features of the book. In contrast, a product identifier immediately distinguishes the book from other books and enables obtaining an immediate and detailed description of the book. For example, an ISBN number for the book may be used to identify the title, author, number of pages, dimensions, and other descriptions of the book. Accordingly, a product identifier provides for an efficient trading of an item or service by defining a standard description for the item or service. In like manner, a qualified product title, as described herein, provides for efficient trading of an item or service, as described by listing on the network-based marketplace 106.

The network-based marketplace 106 includes item inventory in the form of item information 116 and category query information 117. The item information 116 includes listings that describe items or services for sale, as previously described. The category query information 117 includes a single category and queries that were executed in the same category. The network-based marketplace 106 may communicate a copy of the item information 116, in the form of the corpus of item information 112, to the product discovery servers 102 along with category query information 117 to request a product discovery for listings that are registered in the category identified in the category query information 117 but fail to register a product identifier (e.g., qualified product title).

The client device 108 may communicate with the network-based marketplace 106 or the product discovery servers 102. The client device 108 may be operated by user 109 who uses the services of the network-based marketplace 106. For example, the user 109 may include a buyer who buys items/services on the network-based marketplace 106 or a seller who sells items/services on the network-based marketplace 106. In addition, the client device 108 may be operated by administrator for the product discovery servers 102. For example, the administrator may configure the product discovery applications 110 and configurable thresholds or parameters on the product discovery servers 102

The system 100 to discover products in item inventory is now further described. The items described in the corpus of item information 112 that belong to a specific category but without a product identifier may be grouped by the product discovery servers 102 into topics within the category. For example, the category “Smartphones” may include listings that respectively include descriptions of items that are grouped, using the SVD algorithm, into latent topics. The topics may include “iphone,” “samsung,” “unlocked” etc. Each of the listings may further include a title field comprised of candidate phrases (e.g., N-grams) that may be covered by one or more of the topics. Measuring the contribution of each of the candidate phrases (that make up the respective titles) to each of the topics facilitates an identification of significant candidate phrases within the category. Specifically, the SVD algorithm facilitates identification of latent topics within a category. Computing the projections of candidate phrases on the latent topics yields measures of significance for particular candidate phrases to the category. A corpus of item titles may be identified for a specific category. Each title is used to generate a collection of candidate phrases (e.g., title phrases). That is, a title includes a subset of words (e.g., candidate phrases, N-grams) from a larger set of unique words (e.g., candidate phrases) that make up the corpus. The item title corpus may be understood as a set of documents where each document is comprised of a collection of words (e.g., a set of candidate phrases or title phrases) that are generated from the respective title. A term X document matrix “T” may be constructed from these titles with each element in the matrix denoting the presence or absence of a term (e.g., candidate phrase) in a document (title). “T,” in turn, may be decomposed with the SVD algorithm into three matrices: U-matrix, S-matrix, and V-matrix, representing left and right eigen-vectors and eigen-values.

T=U.S.V

Here, “S” is the matrix that represents the magnitude of latent topics or dimensions (e.g., products). “U” represents the projection of each term (e.g., candidate phrase) on the latent dimensions (e.g., products), while “V” represents the projections of documents (e.g., title) on these dimensions (e.g., products). For instance, assume “T” is a 1000×500 matrix with 1000 terms (e.g., candidate phrases) and 500 documents (e.g., title phrases), an SVD with 100 latent dimensions (e.g., products) would result in a decomposition with “U” being a 1000×100 matrix, and “V” being a 100×500 matrix. We are interested in the U-matrix which gives us an insight into the significance of a word (e.g., candidate phrase) to a latent dimension (e.g., product). While different latent dimensions may have varying magnitudes, we retain the top 90% of dimensions by magnitude to reduce noise resulting from by a potential long tail. In our example, if eighty dimensions cover 90% of magnitude, the U-matrix is truncated to represent these top eighty dimensions. The significance of a term (e.g., candidate phrase) is measured by the projection of the term (e.g., candidate phrase) on the most significant dimension (e.g., product). The maximum absolute value of all projections are computed to determine the most significant dimension (e.g., product).

The system 100 to discover products in item inventory is now broadly described as follows. At operation “A,” the product discovery servers 102 receive item information 116 in the form of a corpus of item information 112 from the network-based marketplace 106 and category query information 117 from the network-based marketplace 106. At operation “B,” the product discovery servers 102 extract the titles from listings in the corpus of item information 112 that register without product identifiers and in a particular category (e.g., Smartphones). At operation “C,” the product discovery servers 102 may generate candidate phrases based on the title. At operation “D,” the product discovery servers 102 prune candidate phrases from the candidate phrases to generate pruned candidate phrases. Further at operation “D,” the product discovery servers 102 associates the candidate phrases to latent products by utilizing the SVD algorithm and other algorithms. At operation “E,” the product discovery servers 102 match titles (in the above identified listings) to pruned candidate phrases to identify matched pruned candidate phrases and, at operation “F,” the product discovery servers 102 store the matched pruned candidate servers as qualified product titles (e.g., product identifiers) in the listings to generate a productized corpus of item information 114 that, in turn, is communicated by the product discovery servers 102, over the network 104, to the network-based marketplace 106.

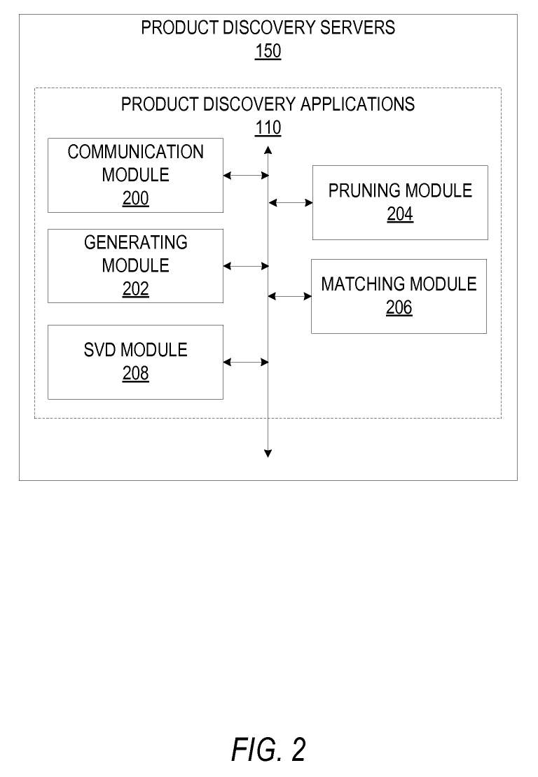

FIG. 2 is a block diagram illustrating product discovery applications 110, according to an example embodiment. The product discovery applications 110 may include a communication module 200, a generating module 202, a pruning module 204, a matching module 206, and an SVD module 208. The communication module 200 may be utilized by the product discovery servers 102 to communicate information over a network 104 and receive information from over the network 104. The information received by the communication module 200 may include the corpus of item information 112 and the information communicated by the communication module 200 may include the productized corpus of item information 114. The generating module 202 may be utilized to generate candidate phrases from the titles in the listings in the corpus of item information 112 that are registered for a particular category but not registered with a product identifier. The pruning module 204 may be used to prune candidate phrases from candidate phrases to identify pruned candidate phrases. To this end, the pruning module 204 may invoke the SVD module 208 which contains the SVD algorithm that returns the “S,” “U,” and “V” matrices, the S and U matrices being utilized to prune candidate phrases 132. The matching module 206 may be utilized to match titles in listings to the longest pruned candidate phrases to identify qualified product titles for each of the listings in the productized corpus of item information 114.

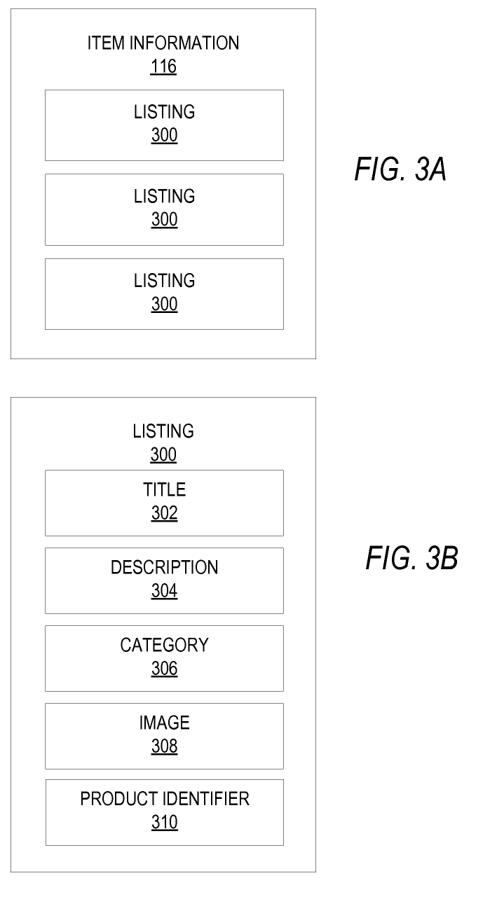

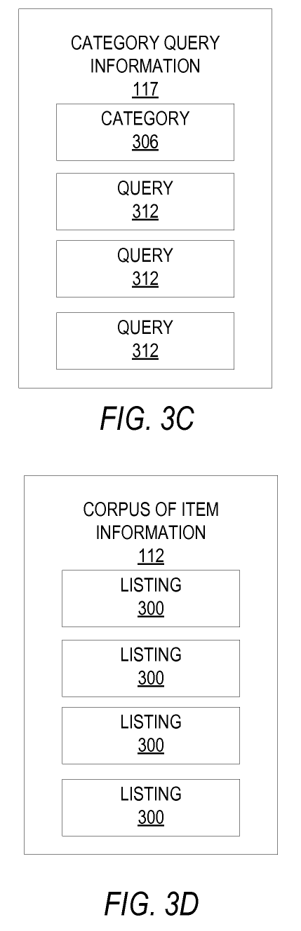

FIG. 3A is a block diagram illustrating item information 116, according to an example embodiment. The item information 116 may be stored on the network-based marketplace 106 and include multiple listings 300 that described various items or services being offered for sale.

FIG. 3B is a block diagram illustrating a listing 300, according to an example embodiment. The listing 300 may include a title 302, a description 304, a category 306, an image 308 and a product identifier 310. The title 302 is an abbreviated summary statement that is provided by the seller. The title 302 describes an item or service that is being offered for sale on the network-based marketplace 106. The description 304 is a lengthy description of the item or service. The category 306 is a classification of a node in a tree like structure that is used to browse listings 300 on the network-based marketplace 106. The image 308 stores a visual presentation of the item or service. The product identifier 310 is an archetype of the item or services that is described by the listing 300. For example, the product identifier 310 may be embodied as a manufacturer part number (MPN), a Global Trade Item Number (GTIN), a Universal Product Code (UPC), International Standard Book Number (ISBN). The present application further describes the product identifier 310 as a qualified product title (QPT).

FIG. 3C is a block diagram illustrating a category query information 117, according to an example embodiment. The category query information 117 may be communicated in one or more communications from the network-based marketplace 106 to the product discovery servers 102 in association with a request to initiate discovery of products in item inventory. The category query information 117 includes a category 306 and multiple queries 312. The category 306 specifies the category 306 in which to discover products in the item inventory (e.g., corpus of item information 112). The queries 312 in the category query information 117 were received from users by the network-based marketplace 106 in association with the specified category 306. For example, a user may enter a query 312 “iPhones 12 Gig” and specify a category 306 (e.g., hand held devices) into a user interface that is being displayed on a client machine that, in turn, communicates the query and the category over the network to the network-based marketplace 106. The network-based marketplace 106 persistently stores the query 312 that is being received based on the specified category 306. Accordingly, network-based marketplace 106 persistently stores queries 312 according to categories 306 on the network-based marketplace 106. Finally, the network-based marketplace 106 communicates the appropriate category query information 117 responsive to a request to initiate a discovery of products in item inventory for a specified category 306, as described above.

FIG. 3D is a block diagram illustrating a corpus of item information 112, according to an example embodiment. The corpus of item information 112 may be communicated in one or more communications from the network-based marketplace 106 to the product discovery servers 102 in association with a request to initiate discovery of products in item inventory. The corpus of item information 112 includes multiple listings 300 that constitute or are representative of the item inventory at the network-based marketplace 106.

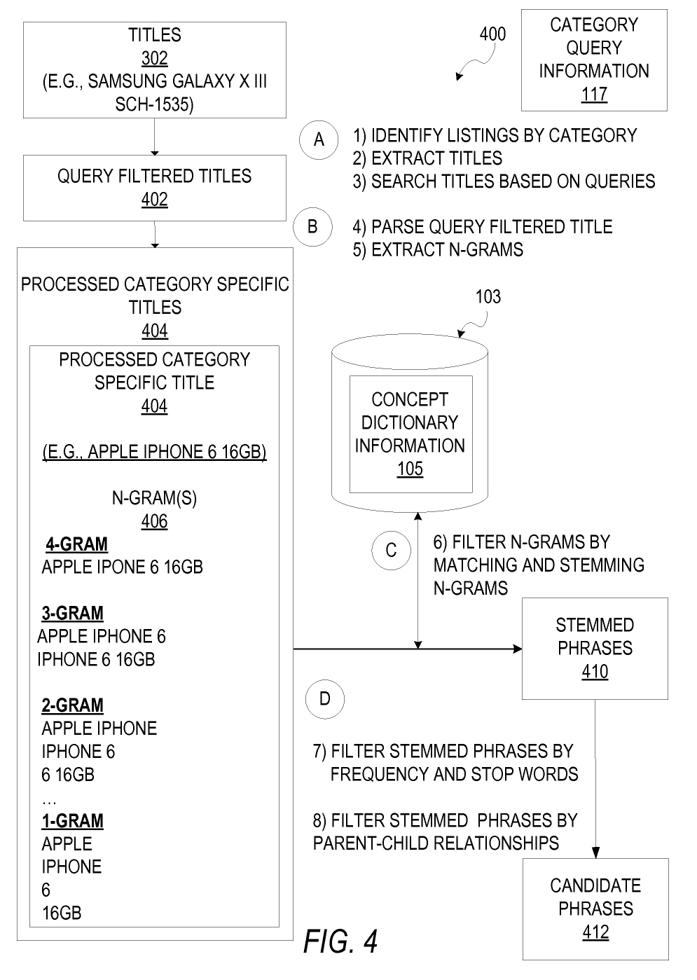

FIG. 4 is a block diagram illustrating a sequence of steps 400 to generate candidate phrases 412, according to an example embodiment. The sequence of steps 400 may be performed by the generating module 202 at the product discovery servers 102, according to an example embodiment. The sequence of steps may include step “A,” step “B,” step “C,” and step “D,” data elements and the database 103 that stores the concept dictionary information 105. The data elements may include titles 302, query filtered titles 402, processed category specific titles 404, stemmed phrases 410, and candidate phrases 412.

At step “A,” the generating module 202 identifies listings 300 in the corpus of item information 112 that match a specified category 306 (e.g., iPhones), and extracts titles 302 from the identified listings 300. For example, the specified title 302 may be identified based on the category 306 that is specified in the category query information 117. Further at step “A,” the generating module 202 searches the titles 302 utilizing queries 312 that were received by the network-based marketplace 106 as category query information 117. For example, the generating module 202 may search the titles 302 with queries 312 for the category 306 (e.g., iPhones) to generate search results in the form of query filtered titles 402.

At step “B,” the generating module 202 parses the query filtered titles 402 to extract N-grams 406. An N-gram 406 is one or more atomic elements included in a sequence of text. For example, the generating module 202 may parse each of the query filtered titles 402 to generate a processed category specific title 404 including one or more N-grams 406. N-grams 406 may include uni-grams, bi-grams, tri-grams, etc. For example, the processed category specific title 404 for “Apple iPhone 6 16 GB Gold (Sprint)” includes the following N-grams 406:

processed category specific title 404
(e.g.,“Apple iPhone 6 16 GB”)
N-grams 406

| Tetra-gram | Tri-gram | Bi-gram | Uni-gram |
|---|---|---|---|
| Apple iPhone 6 16 GB | Apple iPhone 6 | Apple iPhone | Apple |
| | iPhone 6 16 GB | iPhone 6 | iPhone |
| | | 6 16 GB | 6 |
| | | | 16 GB |

At step “C,” the generating module 202 filters the N-grams 406 associated with each processed category specific title 404 to identify stemmed phrases 410. The resulting stemmed phrases 410 are extensions of concepts included in the concept dictionary information 105. Accordingly, step “C” retains stemmed phrases 410 that are meaningful. For example, the processed category specific title 404 for the title 302, “Apple iPhone 6 16 GB,” may be filtered based on the concepts “Apple iPhone” and “6” to generate stemmed phrases 410 including “Apple iPhone 6 16 GB” and “Apple iPhone 6” for the concept “Apple iPhone” and the stemmed phrase “6 16 GB” for the concept “6.”

At step “D,” the generating module 202 filters the stemmed phrases 410 to identify candidate phrases 412. For example, the generating module 202 may remove stemmed phrases 410 that are associated with a frequency that is less than a predetermined threshold (e.g., five). Specifically, the generating module 202 may identify groups of matching stemmed phrases 410 in the corpus of item information including listings 300 that match a particular category, count the number of stemmed phrases 410 in each group, and remove groups having a frequency of five or fewer stemmed phrases 410. Further for example, the generating module 202 may remove stemmed phrases 410 containing only stop words (e.g., the, that, etc.). Specifically, the generating module 202 may identify stemmed phrases 410 in the corpus of item information including listings 300 that match a particular category and including only stop words and remove the identified groups of stemmed phrases 410. Further, the generating module 202 may remove stemmed phrases 410 that are insignificant based on a parent-child relationship. For example, the generating module 202 may remove an insignificant child phrase based on a predetermined threshold (e.g., 5%). Continuing with the example, if the parent stemmed phrase 410 “ABCD” (e.g., 4-gram) is associated with a frequency of two-hundred then a first child stemmed phrase 410 “ABCDE” (5-gram) is removed because of a frequency of ten (e.g., ten “ABCDE” stemmed phrases 410 are identified in the corpus of item information 112 including listings 300 that match a specified category 306 (e.g., iPhones)) but a second child stemmed phrase 410 “ABCDF” (5-gram) is not removed because of a frequency of one-hundred (e.g., one-hundred “ABCDF” stemmed phrase 410 are identified in the corpus of item information 112 including listings 300 that match a specified category 306 (e.g., iPhones)). Further for example, the generating module 202 may remove a duplicate child stemmed phrase 410 based on a predetermined threshold (e.g., 5%). Continuing with the example, if the parent stemmed phrase 410 “ABCD” (4-gram) is associated with a frequency of two-hundred (e.g., two-hundred “ABCD” stemmed phrases 410 are identified in the corpus of item information 112 including listings 300 that match a specified category 306 (e.g., iPhones)) then the first child stemmed phrase 410 “ABCDE” (5-gram) is removed because of a frequency of ten (e.g., ten “ABCDE” stemmed phrases 410 are identified in the corpus of item information 112 including listings 300 that match a specified category 306 (e.g., iPhones)) but a second child stemmed phrase 410 “ABCDF” (5-gram) is not be removed because of a frequency of one-hundred (e.g., one-hundred “ABCDF” stemmed phrases 410 are identified in the corpus of item information 112 including listings 300 that match a specified category 306 (e.g., iPhones)).

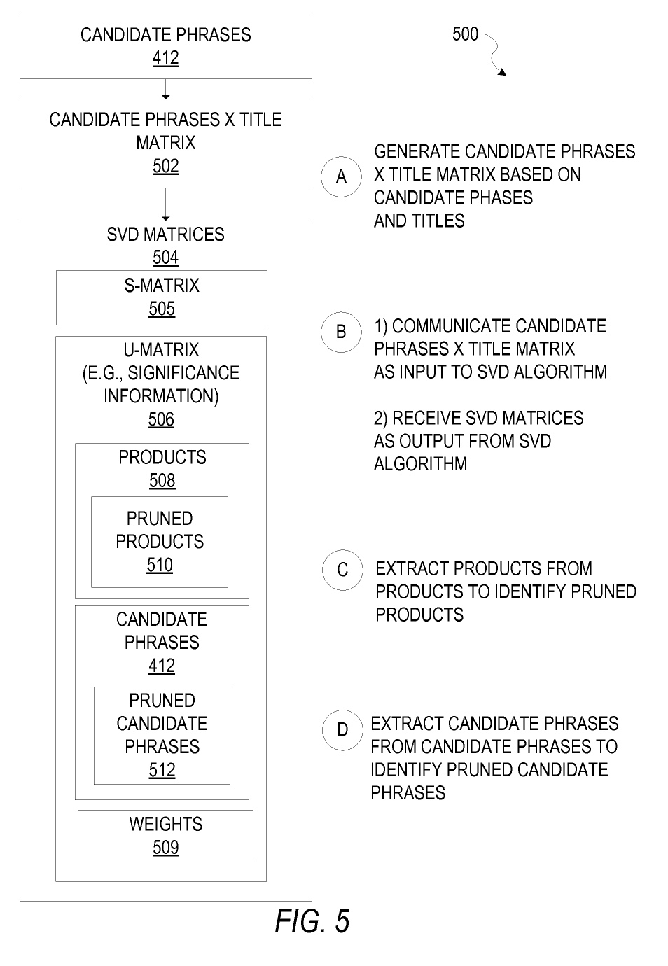

FIG. 5 is a block diagram illustrating a sequence of steps 500 to identify pruned candidate phrases 512, according to an example embodiment. The sequence of steps 500 may be performed by the pruning module 204 (not shown) at the product discovery servers 102 (not shown), according to an example embodiment. The sequence of steps may include step “A,” step “B,” step “C,” and step “D” that are utilized to process data elements including the candidate phrases 412, a candidate phrases x title matrix 502 which is input to a singular value decomposition (SVD) algorithm, and SVD matrices 504 (e.g., U, S, V matrices) which are output of the SVD algorithm. The SVD matrices 504 include an S-matrix 505, a U-matrix 506, and a V-matrix (not shown). The U-matrix 506 includes products 508 that were latent but discovered by the SVD algorithm, candidate phrases 412 and weights 509. The products include pruned products 510 and the candidate phrases 412 include pruned candidate phrases 512.

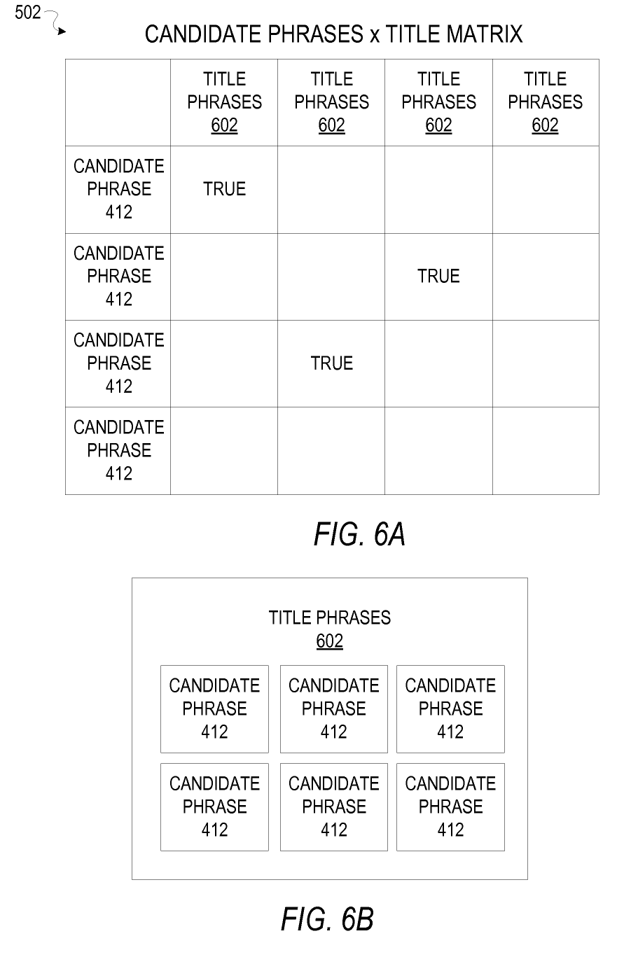

At step “A,” the pruning module 204 receives the candidate phrases 412 and generates the candidate phrases x title matrix 502 (e.g., T). For example, the Y axis of the matrix 502 is comprised of candidate phrases 412 that were generated from the titles 302 and the X axis is comprised of the candidate phrases 412 as organized according to title 302 (e.g., title phrases). Continuing with the example, each column along the X axis (e.g., title phrase) corresponds to a plurality of candidate phrases 412 that were identified based on the title 302. The matrix 502 is described further in FIG. 6A.

At step “B,” the pruning module 204 communicates the matrix 502 to a singular value decomposition (SVD) algorithm that, in turn, generates output comprising the SVD matrices 504 that are returned to the pruning module 204. For example, the matrix 502 that is passed to the SVD algorithm may be comprised of one-thousand candidate phrases 412 x five-hundred titles 302 (e.g., title phrases) respectively comprised of a plurality of candidate phrases 412 that were identified based on the title 302.

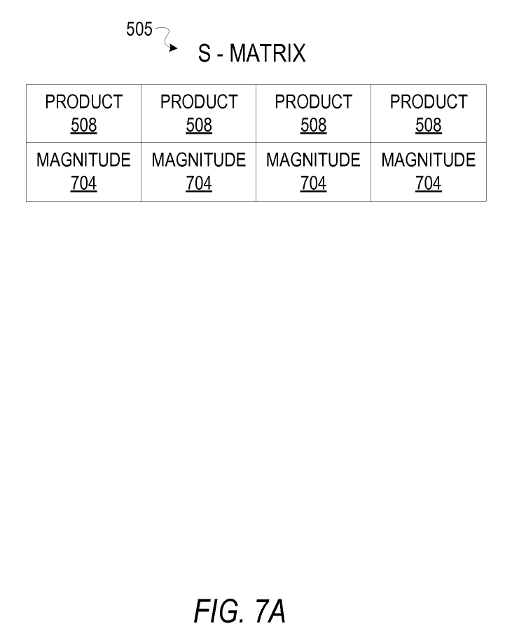

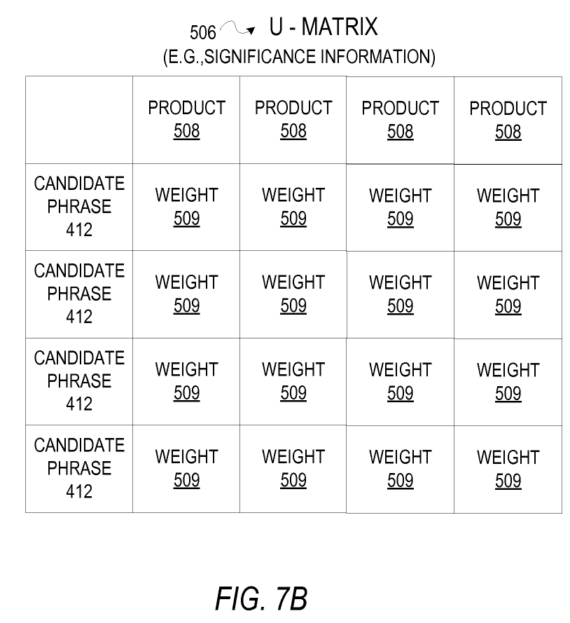

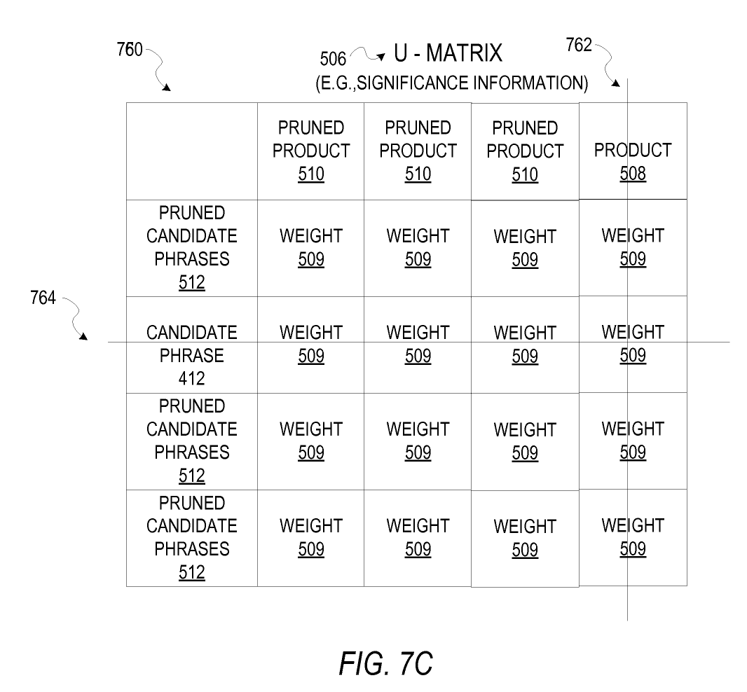

The SVD matrices 504 received from the SVD algorithm are comprised of S, U, and V matrices, as is known by one having ordinary skill in the art. The SVD matrices 504 may be used to discover products 508 that are latent in the matrix 502 based on the distribution of candidate phrases 412 across the titles 302 (e.g., title phrases), according to one embodiment. The “V” matrix is not utilized by the pruning module 204. The “S” matrix identifies a measure of magnitude for each of the products 508 that are discovered in the candidate phrases 412 x title matrix 502, as described further in association with FIG. 7A. The U-matrix 506 is a projection of the candidate phrases 412 against the products 508, as described further in association with FIG. 7B. The U-matrix 506 may be used to identify the significance of a particular candidate phrase 412 for a particular product 508.

At step “C,” the pruning module 204 may extracts products 508 that were discovered. The pruning module 204 may utilize a measure of magnitude in the “S” matrix to extract products 508 from the U-matrix 506 (e.g., significance information) based on a predefined threshold. For example, the pruning module 204 may retain the top 80% of products 508 by magnitude by extracting products 508 from the U-matrix 506 that are associated with lower magnitudes. Continuing with the example, if the U-matrix 506 includes twelve products 508 further including eight products 508 respectively associated with a magnitude of 10% in the “S” matrix and four products 508 respectively associated with magnitudes of 5% in the “S” matrix then the pruning module 204 may the extract four products 508 from the U-matrix 506 that are respectively associated with the magnitude of 5% to retain the top 80% of pruned products 508.

At step “D” the pruning module 204 extracts candidate phrases 412 from the candidate phrases 412 in the U-matrix 506 (e.g., significance information) to identify pruned candidate phrases 512. The pruning module 204 may extract the candidate phrases 412 from the candidate phrases 412 based on a predetermined threshold. For example, the pruning module 204 may sum the weights 509 associated with a particular candidate phrase 412, compare the sum of the weights 509 with a predetermined threshold, and extract candidate phrases 412 above or below the predetermined threshold to yield pruned candidate phrases 512.

FIG. 6A is a block diagram illustrating a candidate phrases by title matrix 502, according to an example embodiment. The candidate phrase by title matrix 502 may be generated by the pruning module 204. The candidate phrases by title matrix 502 is comprised of the candidate phrases 412 as organized according to title 302 in the form of title phrases 602. For example, each column along the “X” axis is for a title phrases 602 element corresponding to a plurality of candidate phrases 412 that were identified based on the title 302. The field of the matrix 502 registers as TRUE or FALSE (e.g., blank) signifying whether the candidate phrase 412 is present in the title phrases 602.

FIG. 6B is a block diagram illustrating title phrases 602, according to an example embodiment. The title phrases 602 element is comprised of one or more candidate phrases 412 (e.g., N-grams 406) that were identified based on a title 302. Merely for example, the title 302 “APPLE IPHONE 6 16 GB” is processed (e.g., step “B,” FIG. 4) to generate a 4-gram (e.g., “APPLE IPHONE 6 16 GB”), 3-grams (“APPLE IPHONE 6,” “IPHONE 6 16 GB”), 2-grams (“APPLE IPHONE,” “IPHONE 6,” “6 16 GB”), and 1-grams (“APPLE,” “IPHONE,” “6,” and “16 GB”) which are stemmed (e.g., step “C,” FIG. 4) and filtered (e.g., step “D,” FIG. 4) to identify candidate phrases 412 for the title 302.

FIG. 7A is a block diagram illustrating an S-matrix 505, according to an example embodiment. The S-matrix 505 includes products 508 that are respectively associated with magnitudes 704. The S-matrix 505 may be generated by an SVD algorithm that is invoked by the pruning module 204 with a candidate phrases by title matrix 502, as previously described. The S-matrix 505 identifies products 508 that were latent in the corpus of item information 112 but nevertheless discovered in the plurality of candidate phrases 412 by the SVD algorithm and the magnitude 704 of each product 508, as generated by the SVD algorithm.

FIG. 7B is a block diagram illustrating the U-matrix 506, according to an example embodiment. The U-matrix 506 (e.g., significance information) includes products 508 that are respectively associated with candidate phrases 412. One having ordinary skill in the art describes the candidate phrase 412 as being projected against the products 508. The candidate phrases 412 are described as being projected against the products 508 for the reason that the intersection of a particular candidate phrase 412 and a particular product 508 is associated with information (e.g., weight 509) that quantifies the significance of the intersection with other intersections. The U-matrix 506 may be generated by an SVD algorithm that, in turn, is invoked by the pruning module 204. The U-matrix 506 indicates the significance of product 508 for a particular candidate phrase 412. The products 508 were latent in the candidate phrases x title matrix 502 but have now been discovered by the SVD algorithm, as presented in the U-matrix 506 (e.g., significance information). The U-matrix 506 includes a field of weights 509. The intersection of a product 508 and a candidate phrase 412 yields a weight 509 that indicates the significance of the particular candidate phrase 412 for the particular product 508.

FIG. 7C is a block diagram illustrating a U-matrix 506, according to an example embodiment, that is pruned. Callout 762 illustrates a product 508 (e.g., column) that is extracted from the U-matrix 506 yielding a remaining set of pruned products 508, as described in step “C” of FIG. 5. Callout 764 illustrates a candidate phrase 412 (e.g., row) that is extracted away from the U-matrix 506 yielding a remaining set of pruned candidate phrases 512, as described in step “D” of FIG. 5.

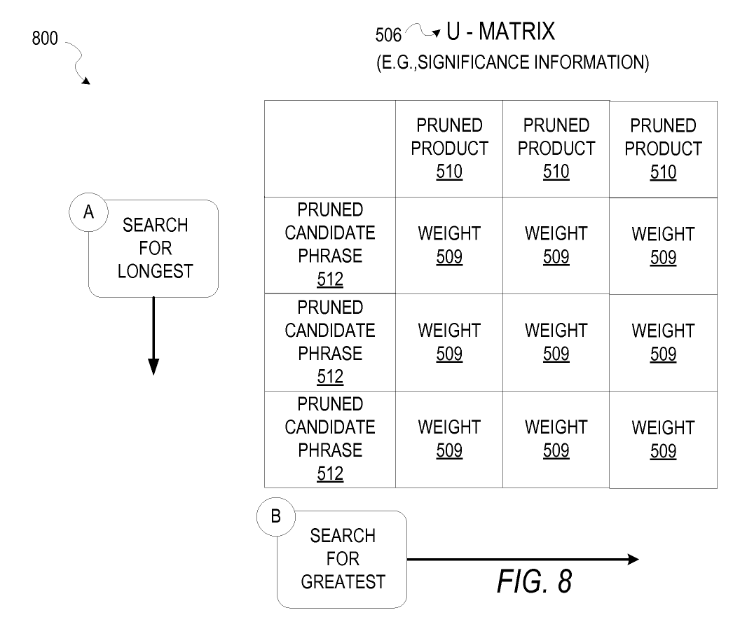

FIG. 8 is a block diagram illustrating a sequence of steps 800 to identify a matched pruned candidate phrase 512, according to an example embodiment. The sequence of steps 800 may be performed by the matching module 206 (not shown) at the product discovery servers 102 (not shown), according to an example embodiment. The sequence of steps may include a step “A” and a step “B” that are performed to process a U-matrix 506 that is pruned. For example, the U-matrix 506 may include pruned products 510 and pruned candidate phrases 512, as previously described.

At step “A,” the matching module 206 compares each of the candidate phrases 412 in title phrases 602 corresponding to a title 302 for a listing 300 with each of the pruned candidate phrases 512 in the U-matrix 506 (e.g., significance information) to identify the longest pruned candidate phrase 512 that matches. The operation is repeated for each of the candidate phrases 412 in the title phrases 602 until the candidate phrases 412 in the title phrases 602 are exhausted.

At step “B,” the matching module 206 identifies the longest matching pruned candidate phrase 512 from all of the pruned candidate phrases 512 found to match the title 302 in step “A.” If more than one pruned candidate phrase 512 is identified as matching the title 302 and as having the same length, then the matching module 206 identifies the matched pruned candidate phrase 512 with the greatest weight 509 as the qualified product title for the title 302 (e.g., listing).

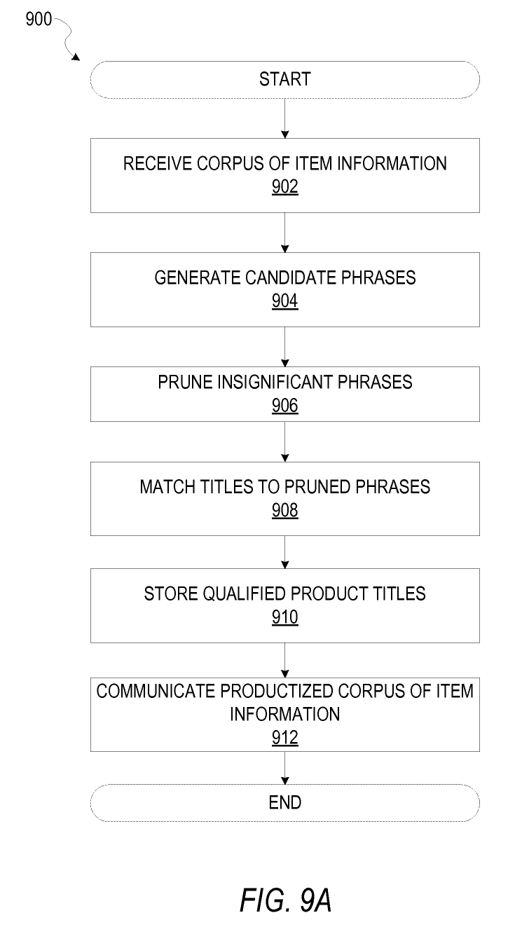

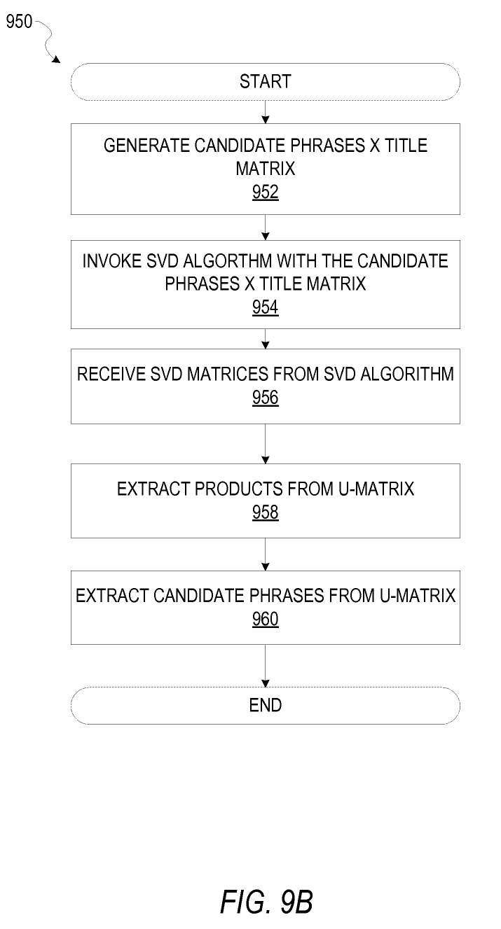

FIG. 9A is a flow chart illustrating a method 900 to discover products 508, according to an example embodiment. The method 900 commences on the product discovery servers 102, at operation 902, with the communication module 200 receiving a communication from the network-based marketplace 106. The communication may include a corpus of item information 112 and category query information 117. Recall that the corpus of item information 112 includes multiple listings 300 and the category query information 117 includes multiple queries 312 for a specified category 306 (e.g., “iPhones”). The listings 300 may describe items that are being offered for sale on a network-based marketplace 106, as previously described

At operation 904, the communication module 200 generates candidate phrases 412 based on the titles 302 in the listings 300. For example, the communication module 200 may generate the candidate phrases 412 in accordance with the steps described in FIG. 4 for the category 306 “iPhones.”

At operation 906, the pruning module 204 prunes insignificant phrases from the plurality of candidate phrases 412 to identify pruned candidate phrases 512. For example, the pruning module 204 may generate the pruned candidate phrases 512 in accordance with the steps described in FIG. 5.

At operation 908, the matching module 206 matches each of the candidate phrases 412 for a title 302 from the corpus of item information 112 to pruned candidate phrase 512 in the U-matrix 506 to identify the longest pruned candidate phrase 512 that matches the title 302. For example, the pruning module 204 may generate and match the pruned candidate phrases 512 in accordance with the steps described in FIG. 8 to identify the longest pruned candidate phrase 512 that matches the title 302. The matching module 206 repeats the above sequence of steps for each of the titles 302 in the corpus of item information 112.

At operation 910, the communication module 200 stores the matched pruned candidate phrases 512 as qualified product titles in the listings 300 to generate a productized corpus of item information 114. At operation 912, the communication module 200 communicates the productized corpus of item information 114, over the network 104, to the network-based marketplace 106.

In another embodiment, the product discovery applications 110 may execute on the network-based marketplace 106 instead of the product discovery servers 102.

FIG. 9B is a block diagram illustrating a method 950 to prune insignificant phrases, according to an example embodiment. The method 950 commences on the product discovery servers 102, at operation 952, with the pruning module 204 generating a candidate phrases x title matrix 502, as described in FIG. 5.

At operation 954, the pruning module 204 generates SVD matrices 504, as described in FIG. 5, by invoking a SVD algorithm. For example, the pruning module 204 may invoke the SVD algorithm by communicating the candidate phrases x title matrix 502, as a matrix comprised of input, to the SVD algorithm. The SVD algorithm executes a sequence of steps to generate the SVD matrices 504. The SVD matrices 504 include an S-matrix 505, a U-matrix 506 (e.g., significance information) and a V-matrix, that is presently not used. The SVD algorithm, among other steps, projects the candidate phrases 412 generated from the corpus of item information 112 against itself, but is organized according to titles 302 (e.g., title phrases 602), to identify (e.g., generate) the U-matrix 506 (e.g., significance information). Recall the U-matrix 506 (e.g., significance information) includes candidate phrases 412 that are projected against a plurality of products 508 that were latent in the candidate phrases x title matrix 502 and discovered by the SVD algorithm. The U-matrix 506 further includes a field of weights 509 where each weight 509 corresponds to an intersection of a candidate phrase 412 and product 508, as illustrated in FIG. 7B.

At operation 956, the pruning module 204 receives the SVD matrices 504, as described in FIG. 5, from the SVD algorithm.

At operation 958, the pruning module 204 extracts products 508 from the U-matrix 506 (e.g., significance information) to yield the pruned products 510 in the U-matrix 506, as described in association with FIG. 7C.

At operation 960, the pruning module 204 extracts candidate phrases 412 from the U-matrix 506 (e.g., significance information) to yield the pruned candidate phrases 512 in the U-matrix 506, as described in association with FIG. 7C.

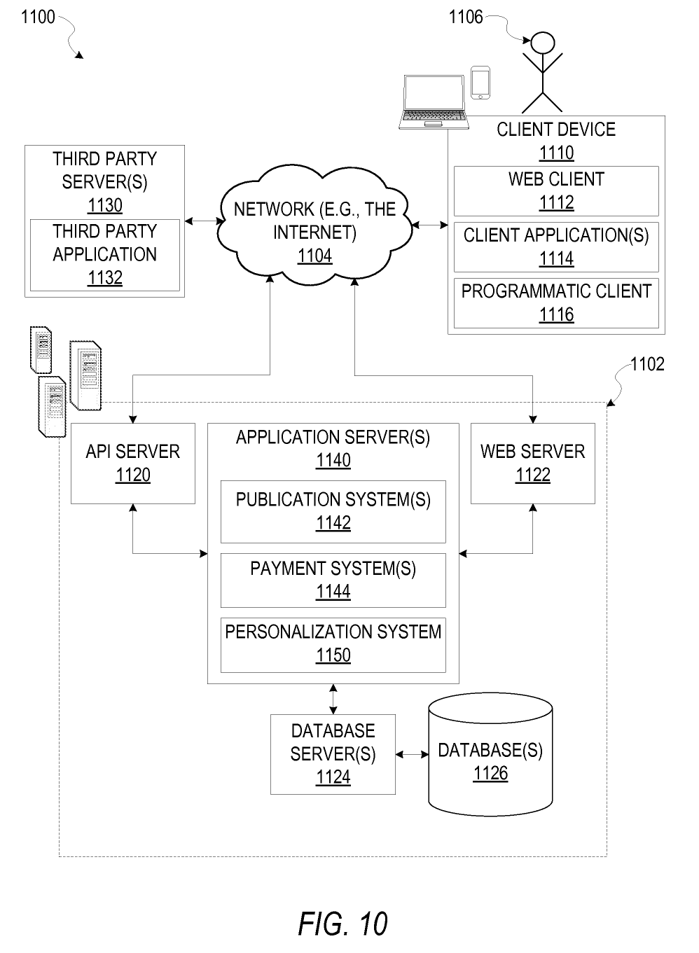

FIG. 10 is a block diagram illustrating a system 1100 to discover products in an inventory, according to an example embodiment. The system 1100 is an example embodiment of a high-level client-server-based network architecture. The system 1100 includes a networked system 1102, in the example forms of a network-based marketplace 106 or payment system, which provides server-side functionality via a network 1104 (e.g., the Internet or wide area network (WAN)) to one or more client devices 1110. FIG. 10 illustrates, for example, a web client 1112 (e.g., a browser, such as the Internet Explorer® browser developed by Microsoft® Corporation of Redmond, Wash. State), an application 1114, and a programmatic client 1116 executing on client device 1110.

The client device 1110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user 109 may utilize to access the networked system 1102. In some embodiments, the client device 1110 may comprise a display module (not shown) to display information (e.g., in the form of user interfaces). In further embodiments, the client device 1110 may comprise one or more of a touch screens, accelerometers, gyroscopes, cameras, microphones, global positioning system (GPS) devices, and so forth. The client device 1110 may be a device of a user 109 that is used to perform a transaction involving digital items within the networked system 1102. In one embodiment, the networked system 1102 is a network-based marketplace 106 that responds to requests for product listings, publishes publications comprising item listings of products 508 available on the network-based marketplace 106, and manages payments for these marketplace transactions. One or more users 1106 may be a person, a machine, or other means of interacting with client device 1110. In embodiments, the user 1106 is not part of the network architecture 1100, but may interact with the network architecture 1100 via client device 1110 or another means. For example, one or more portions of network 1104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 1110 may include one or more applications 1114 (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 1110, then this application is configured to locally provide the user interface and at least some of the functionalities with the application configured to communicate with the networked system 1102, on an as needed basis, for data and/or processing capabilities not locally available (e.g., access to a database 306 of items available for sale, to authenticate a user 1106, to verify a method of payment, etc.). Conversely, if the e-commerce site application is not included in the client device 1110, the client device 1110 may use its web browser to access the e-commerce site (or a variant thereof) hosted on the networked system 1102.

One or more users 1106 may be a person, a machine, or other means of interacting with the client device 1110. For instance, the user 1106 provides input (e.g., touch screen input or alphanumeric input) to the client device 1110 and the input is communicated to the networked system 1102 via the network 1104. In this instance, the networked system 1102, in response to receiving the input from the user 1106, communicates information to the client device 1110 via the network 1104 to be presented to the user 1106. In this way, the user 1106 can interact with the networked system 1102 using the client device 1110.

An application program interface (API) server 1120 and a web server 1122 are coupled to, and provide programmatic and web interfaces respectively to, one or more application servers 1140. The application servers 1140 may host one or more publication systems 1142 and payment systems 1144, each of which may comprise one or more modules or applications and each of which may be embodied as hardware, software, firmware, or any combination thereof. The application servers 1140 are, in turn, shown to be coupled to one or more database servers 1124 that facilitate access to one or more information storage repositories or database(s) 1126. In an example embodiment, the databases 1126 are storage devices that store information to be posted (e.g., publications or listings 300) to the publication system 1142. The databases 1126 may also store digital item information 116 in accordance with example embodiments.

Additionally, a third party application 1132, executing on third party server(s) 1130, is shown as having programmatic access to the networked system 1102 via the programmatic interface provided by the API server 1120. For example, the third party application 1132, utilizing information retrieved from the networked system 1102, supports one or more features or functions on a website hosted by the third party. The third party website, for example, provides one or more promotional, marketplace, or payment functions that are supported by the relevant applications of the networked system 1102. For example, the promotional, marketplace, or payment functions may include the discovery of products 508 in item inventory as described herein. To this end, the third party applications 1132 may include the product discovery applications 110.

The publication systems 1142 may provide a number of publication functions and services to users 1106 that access the networked system 1102. The payment systems 1144 may likewise provide a number of functions to perform or facilitate payments and transactions. While the publication system 1142 and payment system 1144 are shown in FIG. 1 to both form part of the networked system 1102, it will be appreciated that, in alternative embodiments, each system 1142 and 1144 may form part of a payment service that is separate and distinct from the networked system 1102. In some embodiments, the payment systems 1144 may form part of the publication system 1142.

The personalization system 1150 may provide functionality operable to perform various personalization using the user selected data. For example, the personalization system 1150 may access the user selected data from the databases 1126, the third party servers 1130, the publication system 1142, and other sources. In some example embodiments, the personalization system 1150 may analyze the user data to perform personalization of user preferences. As more content is added to a category 306 by the user 1106, the personalization system 1150 can further refine the personalization. In some example embodiments, the personalization system 1150 may communicate with the publication systems 1142 (e.g., accessing item listings) and payment system 1144. In an alternative example embodiment, the personalization system 1150 may be a part of the publication system 1142.

Further, while the client-server-based network architecture 1100 shown in FIG. 1 employs a client-server architecture, the present inventive subject matter is, of course, not limited to such an architecture, and could equally well find application in a distributed, or peer-to-peer, architecture system, for example. The various publication system 1142, payment system 1144, and personalization system 1150 could also be implemented as standalone software programs, which do not necessarily have networking capabilities.

The web client 1112 may access the various publication and payment systems 1142 and 1144 via the web interface supported by the web server 1122. Similarly, the programmatic client 1116 accesses the various services and functions provided by the publication and payment systems 1142 and 1144 via the programmatic interface provided by the API server 1120. The programmatic client 1116 may, for example, be a seller application (e.g., the Turbo Lister application developed by eBay® Inc., of San Jose, Calif.) to enable sellers to author and manage listings 300 on the networked system 1102 in an off-line manner, and to perform batch-mode communications between the programmatic client 1116 and the networked system 1102.

Additionally, a third party application(s) 1132, executing on a third party server(s) 1130, is shown as having programmatic access to the networked system 1102 via the programmatic interface provided by the API server 1120. For example, the third party application 1132, utilizing information retrieved from the networked system 1102, may support one or more features or functions on a website hosted by the third party. The third party website may, for example, provide one or more promotional, marketplace, or payment functions that are supported by the relevant applications of the networked system 1102.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application 1114 or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application specific integrated circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network 1104 (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications 1114, and so forth, described in conjunction with FIGS. 4-10 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

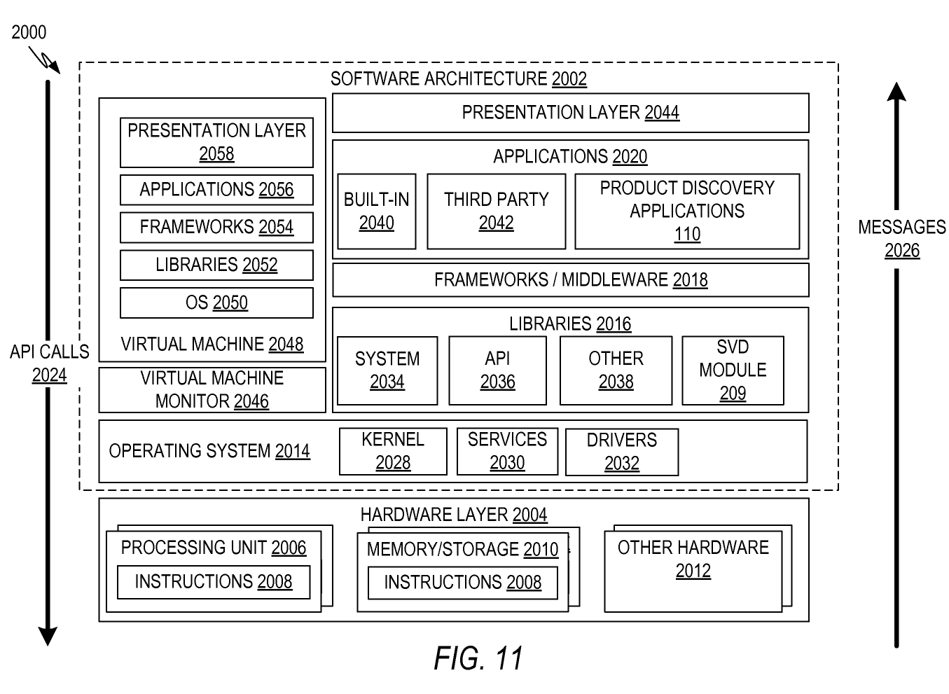

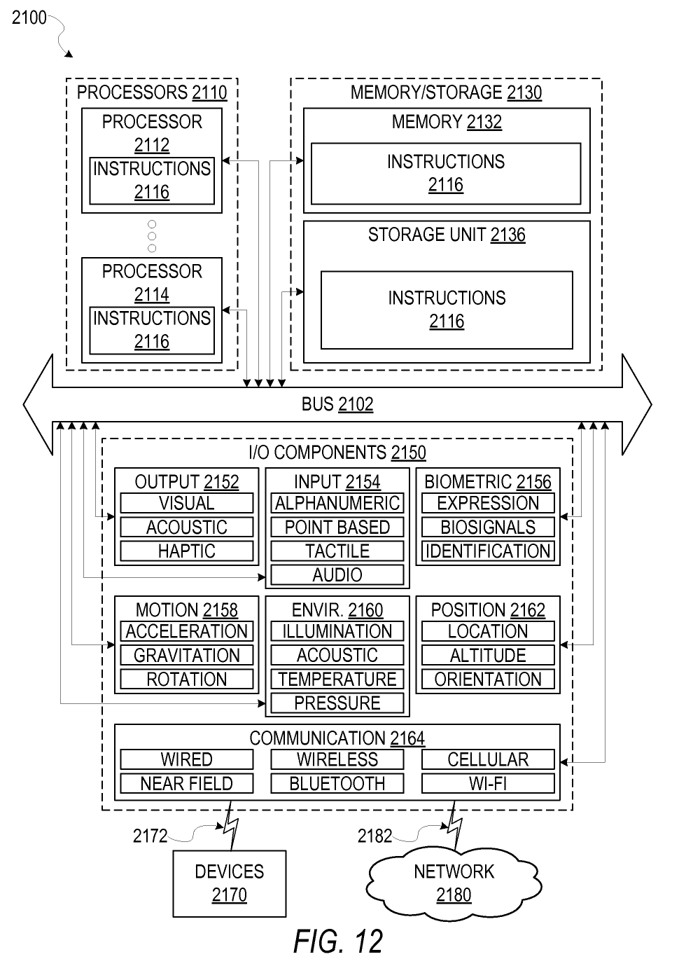

FIG. 11 is a block diagram 2000 illustrating a representative software architecture 2002, which may be used in conjunction with various hardware architectures herein described. FIG. 11 is merely a non-limiting example of a software architecture and it will be appreciated that many other architectures may be implemented to facilitate the functionality described herein. The software architecture 2002 may be executing on hardware such as machine 2100 of FIG. 12 that includes, among other things, processors 2110, memory 2130, and I/O components 2150. A representative hardware layer 2004 is illustrated and can represent, for example, the machine 2100 of FIG. 12. The representative hardware layer 2004 comprises one or more processing units 2006 having associated executable instructions 2008. Executable instructions 2008 represent the executable instructions 2008 of the software architecture 2002, including implementation of the methods, modules and so forth of FIGS. 4-10. Hardware layer 2004 also includes memory and/or storage modules 2010, which also have executable instructions 2008. Hardware layer 2004 may also comprise other hardware as indicated by 2012 which represents any other hardware of the hardware layer 2004, such as the other hardware illustrated as part of machine 2100.

In the example architecture of FIG. 11, the software 2002 may be conceptualized as a stack of layers where each layer provides particular functionality. For example, the software 2002 may include layers such as an operating system 2014, libraries 2016, frameworks/middleware 2018, applications 2020 and presentation layer 2044. Operationally, the applications 2020 and/or other components within the layers may invoke application programming interface (API) calls 2024 through the software stack and receive a response, returned values, and so forth illustrated as messages 2026 in response to the API calls 2024. The layers illustrated are representative in nature and not all software architectures have all layers. For example, some mobile or special purpose operating systems may not provide a frameworks/middleware layer 2018, while others may provide such a layer. Other software architectures may include additional or different layers.

The operating system 2014 may manage hardware resources and provide common services. The operating system 2014 may include, for example, a kernel 2028, services 2030, and drivers 2032. The kernel 2028 may act as an abstraction layer between the hardware and the other software layers. For example, the kernel 2028 may be responsible for memory management, processor management (e.g., scheduling), component management, networking, security settings, and so on. The services 2030 may provide other common services for the other software layers. The drivers 2032 may be responsible for controlling or interfacing with the underlying hardware. For instance, the drivers 2032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 2016 may provide a common infrastructure that may be utilized by the applications 2020 and/or other components and/or layers. The libraries 2016 typically provide functionality that allows other software modules to perform tasks in an easier fashion than to interface directly with the underlying operating system 2014 functionality (e.g., kernel 2028, services 2030 and/or drivers 2032). The libraries 2016 may include system 2034 libraries (e.g., C standard library) that may provide functions such as memory allocation functions, string manipulation functions, mathematic functions, and the like. In addition, the libraries 2016 may include API libraries 2036 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 2016 may also include a wide variety of other libraries 2038 to provide many other APIs to the applications 2020 and other software components/modules as well as the SVD module 208 including an SVD algorithm, as described herein.

The frameworks 2018 (also sometimes referred to as middleware) may provide a higher-level common infrastructure that may be utilized by the applications 2020 and/or other software components/modules. For example, the frameworks 2018 may provide various graphic user interface (GUI) functions, high-level resource management, high-level location services, and so forth. The frameworks 2018 may provide a broad spectrum of other APIs that may be utilized by the applications 2020 and/or other software components/modules, some of which may be specific to a particular operating system 2014 or platform.

The applications 2020 includes built-in applications 2040 and/or third party applications 2042 and/or product discovery applications 110, as described herein. Examples of representative built-in applications 2040 may include, but are not limited to, a contacts application, a browser application, a book reader application, a location application, a media application, a messaging application, and/or a game application. Third party applications 2042 may include any of the built in applications as well as a broad assortment of other applications. In a specific example, the third party application 2042 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 2042 may invoke the API calls 2024 provided by the mobile operating system such as operating system 2014 to facilitate functionality described herein.

The applications 2020 may utilize built in operating system functions (e.g., kernel 2028, services 2030 and/or drivers 2032), libraries (e.g., system 2034, APIs 2036, and other libraries 2038), frameworks/middleware 2018 to create user interfaces to interact with users 1106 of the system. Alternatively, or additionally, in some systems interactions with a user 1106 may occur through a presentation layer, such as presentation layer 2044. In these systems, the application/module “logic” can be separated from the aspects of the application/module that interact with a user 1106.

Some software architectures utilize virtual machines. In the example of FIG. 10, this is illustrated by virtual machine 2048. A virtual machine 2048 creates a software environment where applications 2020/modules can execute as if they were executing on a hardware machine (such as the machine 2100 of FIG. 12, for example). A virtual machine 2048 is hosted by a host operating system (operating system 2014 in FIG. 11) and typically, although not always, has a virtual machine monitor 2046, which manages the operation of the virtual machine 2048 as well as the interface with the host operating system (i.e., operating system 2014). A software architecture executes within the virtual machine 2048 such as an operating system 2050, libraries 2052, frameworks/middleware 2054, applications 2056 and/or presentation layer 2058. These layers of software architecture executing within the virtual machine 2048 can be the same as corresponding layers previously described or may be different.

### Example Machine Architecture and Machine-Readable Medium

FIG. 12 is a block diagram illustrating components of a machine 2100, according to some example embodiments, able to read instructions 2116 from a machine-readable medium (e.g., a machine-readable storage medium) and perform any one or more of the methodologies discussed herein. Specifically, FIG. 11 shows a diagrammatic representation of the machine 2100 in the example form of a computer system, within which instructions 2116 (e.g., software, a program, an application 2020, an applet, an app, or other executable code) for causing the machine 2100 to perform any one or more of the methodologies discussed herein may be executed. For example, the instructions 2116 may cause the machine 2100 to execute the flow diagrams of FIGS. 4-10. Additionally, or alternatively, the instructions 2116 may implement product discovery applications 110 of FIG. 2, and so forth. The instructions 2116 transform the general, non-programmed machine 2100 into a particular machine 2100 programmed to carry out the described and illustrated functions in the manner described. In alternative embodiments, the machine 2100 operates as a standalone device or may be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2116, sequentially or otherwise, that specify actions to be taken by machine 2100. Further, while only a single machine 2100 is illustrated, the term “machine” shall also be taken to include a collection of machines 2100 that individually or jointly execute the instructions 2116 to perform any one or more of the methodologies discussed herein.

The machine 2100 may include processors 2110, memory 2130, and I/O components 2150, which may be configured to communicate with each other such as via a bus 2102. In an example embodiment, the processors 2110 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 2112 and processor 2114 that may execute instructions 2116. The term “processor” is intended to include a multi-core processor 2110 that may comprise two or more independent processors 2112, 2114 (sometimes referred to as “cores”) that may execute instructions 2116 contemporaneously. Although FIG. 12 shows multiple processors 2112, 2114, the machine 2100 may include a single processor 2112 with a single core, a single processor 2112 with multiple cores (e.g., a multi-core processor), multiple processors 2112, 2114 with a single core, multiple processors 2112, 2114 with multiples cores, or any combination thereof

The memory/storage 2130 may include a memory 2132, such as a main memory, or other memory storage, and a storage unit 2136, both accessible to the processors 2110 such as via the bus 2102. The storage unit 2136 and memory 2132 store the instructions 2116 embodying any one or more of the methodologies or functions described herein. The instructions 2116 may also reside, completely or partially, within the memory 2132, within the storage unit 2136, within at least one of the processors 2110 (e.g., within the processor's cache memory), or any suitable combination thereof, during execution thereof by the machine 2100. Accordingly, the memory 2132, the storage unit 2136, and the memory of processors 2110 are examples of machine-readable media.

As used herein, “machine-readable medium” means a device able to store instructions 2116 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)) and/or any suitable combination thereof. The term “machine-readable medium” should be taken to include a single medium or multiple media (e.g., a centralized or distributed database, or associated caches and servers) able to store instructions 2116. The term “machine-readable medium” shall also be taken to include any medium, or combination of multiple media, that is capable of storing instructions (e.g., instructions 2116) for execution by a machine (e.g., machine 2100), such that the instructions 2116, when executed by one or more processors of the machine 2100 (e.g., processors 2110), cause the machine 2100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 2150 may include a wide variety of components to receive input, provide output, produce output, transmit information, exchange information, capture measurements, and so on. The specific I/O components 2150 that are included in a particular machine 2100 will depend on the type of machine 2100. For example, portable machines such as mobile phones will likely include a touch input device or other such input mechanisms, while a headless server machine will likely not include such a touch input device. It will be appreciated that the I/O components 2150 may include many other components that are not shown in FIG. 12. The I/O components 2150 are grouped according to functionality merely for simplifying the following discussion and the grouping is in no way limiting. In various example embodiments, the I/O components 2150 may include output components 2152 and input components 2154. The output components 2152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 2150 may include biometric components 2156, motion components 2158, environmental components 2160, or position components 2162 among a wide array of other components. For example, the biometric components 2156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2158 may include acceleration sensor components (e.g., accelerometer), gravitation sensor components, rotation sensor components (e.g., gyroscope), and so forth. The environmental components 2160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2150 may include communication components 2164 operable to couple the machine 2100 to a network 2180 or devices 2170 via coupling 2182 and coupling 2172 respectively. For example, the communication components 2164 may include a network interface component or other suitable device to interface with the network 2180. In further examples, communication components 2164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 2170 may be another machine or any of a wide variety of peripheral devices (e.g., a peripheral device coupled via a Universal Serial Bus (USB)).

Moreover, the communication components 2164 may detect identifiers or include components operable to detect identifiers. For example, the communication components 2164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2164, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 2180 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 2180 or a portion of the network 2180 may include a wireless or cellular network and the coupling 2182 may be a Code Division Multiple Access (CDMA) connection, a Global System for Mobile communications (GSM) connection, or other type of cellular or wireless coupling. In this example, the coupling 2182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 2116 may be transmitted or received over the network 2180 using a transmission medium via a network interface device (e.g., a network interface component included in the communication components 2164) and utilizing any one of a number of well-known transfer protocols (e.g., hypertext transfer protocol (HTTP)). Similarly, the instructions 2116 may be transmitted or received using a transmission medium via the coupling 2172 (e.g., a peer-to-peer coupling) to devices 2170. The term “transmission medium” shall be taken to include any intangible medium that is capable of storing, encoding, or carrying instructions 2116 for execution by the machine 2100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The example embodiments illustrated herein are described in sufficient detail to enable those skilled in the art to practice the teachings disclosed. Other example embodiments may be used and derived therefrom, such that structural and logical substitutions and changes may be made without departing from the scope of this disclosure. The Detailed Description, therefore, is not to be taken in a limiting sense, and the scope of various example embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various example embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of example embodiments of the present disclosure as represented by the appended claims. The specification and drawings are, accordingly, to be regarded in an illustrative rather than a restrictive sense.

What is claimed is:

1. A system comprising:
a communication module, using at least one processor of a machine, that is configured to receive a corpus of item information from a sender, the corpus of item information including a plurality of listings that respectively describe a plurality of items that are categorized in a same category and offered for sale on a network-based marketplace, the plurality of listings including a plurality of titles but no product identifiers;
a generating module that is configured to generate a plurality of candidate phrases based on the plurality of titles;
a pruning module that is configured to prune a plurality of insignificant phrases from the plurality of candidate phrases to identify a plurality of pruned candidate phrases, the pruning module is configured to project the plurality of candidate phrases against itself, as the plurality of titles, to identify significance information, the significance information including the plurality of candidate phrases projected against a plurality of products, the pruning module being configured to extract the plurality of insignificant phrases from the plurality of candidate phrases based on the significance information, the pruning module being configured to extract based on the significance information;
a matching module that is configured to match the plurality of titles to the plurality of pruned candidate phrases based on the significance information to identify a plurality of matched pruned candidate phrases, the plurality of pruned candidate phrases include a pruned candidate phrase, the matching module is configured to identify a longest pruned candidate phrase that matches a title, the communication module being configured to store the plurality of matched pruned candidate phrases as qualified product titles in the plurality of listings to generate a productized corpus of item information, the communication module being configured to communicate the productized corpus of item information to the sender.

2. The system of claim 1, wherein the pruning module is configured to utilize a singular value decomposition algorithm to project the plurality of the pruned candidate phrases against itself.

3. The system of claim 1, wherein the significance information further includes a first plurality of weights that are associated with the plurality of products.

4. The system of claim 3, wherein the plurality of pruned candidate phrases further includes a first pruned candidate phrase, and wherein the first plurality of weights includes a second plurality of weights.

5. The system of claim 4, wherein the pruning module is configured to assign the second plurality of weights to the first pruned candidate phrase.

6. The system of claim 5, wherein the pruning module is configured to distinguish between each of a set of longest pruned candidate phrases, including the first pruned candidate phrase, that match a particular title based on the second plurality of weights.

7. The system of claim 1, wherein the generating module is configured to generate a plurality of n-gram phrases based on the plurality of titles.

8. The system of claim 7, wherein the generating module is configured to filter the plurality of n-grams phrases based on a plurality of queries that were received by the network-based marketplace in association with the same category.

9. The system of claim 2, wherein the pruning module is configured to utilize a latent dirichlet allocation algorithm to identify the significance information that discovers the plurality of products.

10. A method comprising:
receiving a corpus of item information from a sender, the corpus of item information including a plurality of listings respectively describing a plurality of items that are categorized in the same category and being offered for sale on a network-based marketplace, the plurality of listings including a plurality of titles but no product identifiers;
generating a plurality of candidate phrases based on the plurality of titles;
pruning a plurality of insignificant phrases from the plurality of candidate phrases to identify a plurality of pruned candidate phrases, the pruning comprising:
projecting the plurality of candidate phrases against itself, as the plurality of titles, to identify significance information, the significance information including the plurality of candidate phrases projected against a plurality of products,
extracting the plurality of insignificant phrases from the plurality of candidate phrases based on the significance information, the extracting based on the significance information;
matching the plurality of titles to the plurality of pruned candidate phrases based on the significance information to identify a plurality of matched pruned candidate phrases, the plurality of pruned candidate phrases include a pruned candidate phrase, the matching including identifying a longest pruned candidate phrase that matches a title;
storing the plurality of matched pruned candidate phrases as qualified product titles in the plurality of listings in accordance with the matching to generate a productized corpus of item information; and
communicating the productized corpus of item information to the sender.

11. The method of claim 10, wherein the projecting further comprises utilizing a singular value decomposition algorithm to project the plurality of the pruned candidate phrases against itself.

12. The method of claim 10, wherein the significance information further includes a first plurality of weights that are associated with the plurality of products.

13. The method of claim 12, wherein the plurality of pruned candidate phrases further includes a first pruned candidate phrase, and wherein the first plurality of weights includes a second plurality of weights.

14. The method of claim 13, wherein the projecting further comprises assigning the second plurality of weights to the first pruned candidate phrase.

15. The method of claim 14, wherein the identifying the longest pruned candidate phrase comprises distinguishing between each of a set of longest pruned candidate phrases, including the first pruned candidate phrase, that match a particular title based on the second plurality of weights.

16. The method of claim 10, wherein the generating the plurality of candidate phrases based on the plurality of titles further comprises generating a plurality of n-gram phrases based on the plurality of titles.

17. The method of claim 10, wherein the generating the plurality of candidate phrases based on the plurality of titles further comprises filtering a plurality of n-grams phrases based on a plurality of queries that were received by the network-based marketplace in association with the same category.

18. The method of claim 11, wherein the projecting further comprises utilizing a latent dirichlet allocation algorithm to identify the significance information that discovers the plurality of products.

19. A machine-readable medium storing instructions having no transitory signals and that, when executed by at least one processor, cause at least one processor to perform actions comprising:
receiving a corpus of item information from a sender, the corpus of item information including a plurality of listings respectively describing a plurality of items that are categorized in the same category and being offered for sale on a network-based marketplace, the plurality of listings including a plurality of titles but no product identifiers;
generating a plurality of candidate phrases based on the plurality of titles;
pruning a plurality of insignificant phrases from the plurality of candidate phrases to identify a plurality of pruned candidate phrases, the pruning comprising:
projecting the plurality of candidate phrases against itself, as the plurality of titles, to identify significance information, the significance information including the plurality of candidate phrases projected against a plurality of products,
extracting the plurality of insignificant phrases from the plurality of candidate phrases based on the significance information, the extracting based on the significance information;
matching the plurality of titles to the plurality of pruned candidate phrases based on the significance information to identify a plurality of matched pruned candidate phrases, the plurality of pruned candidate phrases include a pruned candidate phrase, the matching including identifying a longest pruned candidate phrase that matches a title;
storing the plurality of matched pruned candidate phrases as qualified product titles in the plurality of listings in accordance with the matching to generate a productized corpus of item information; and
communicating the productized corpus of item information to the sender.

20. The machine-readable medium of claim 19, wherein the projecting further comprises utilizing a singular value decomposition algorithm to project the plurality of the pruned candidate phrases against itself.
